(19) United States
(12) Patent Application Publication
(10) Pub. No.: US 2023/0377815 A1
(43) Pub. Date: Nov. 23, 2023

(54) ALL-IN-ONE-SECURITY SYSTEM CONTROLLER WITH TACTILE INPUT

(71) Applicant: Luna Products LLC, Carlsbad, CA (US)

(72) Inventors: Bruce James Ehlers, Encinitas, CA (US); Anthony Triana, San Diego, CA (US); Christopher Laguer Acera, Carlsbad, CA (US); Eric Paxton, Oceanside, CA (US); Jesus Abrego, Vista, CA (US); Joseph James Esqueda, Encinitas, CA (US); Robert Raymond Reichert, Prescott Valley, AZ (US); Mel Aguilera, Murrieta, CA (US)

(21) Appl. No.: 18/125,699

(22) Filed: Mar. 23, 2023

Related U.S. Application Data
(60) Provisional application No. 63/322,992, filed on Mar. 23, 2022.

(51) Int. Cl. H01H 13/83; G06F 3/02

(52) U.S. Cl. CPC H01H 13/83; G06F 3/0202; H01H 2219/039

(57) ABSTRACT

An improved small form factor controller includes a tactile input surface with a predetermined pattern of input regions. The pattern of input regions may be illuminated by the controller, and preferably would be generally imperceptible in the absence of illumination. The tactile input surface includes an array of regions that can be correlated with particular input regions on an illumination pattern. The tactile input surface includes an array of regions that can be correlated with particular input regions on an illumination pattern. A processor monitors for tactile input from the user and converts a motion pattern performed by the user to a sequence of corresponding activations, which is compared with stored user codes.

### CROSS-REFERENCE TO RELATED APPLICATIONS

The present application claims the benefit of U.S. Provisional Application No. 63/322,992, filed Mar. 23, 2022, the entire disclosure of which is incorporated by reference herein.

### FIELD OF THE INVENTION

This disclosure relates generally to small form factor controllers with touch sensitive inputs. More specifically, this disclosure relates to reduced size all-in-one security system controllers with tactile input and swiping capabilities.

### BACKGROUND

Common security system controllers contain a relatively large LCD screen, or simple mechanical buttons provided in a large chassis. The controllers may also connect multiple discrete input devices together, increasing the footprint and cost of the controller. Controller inputs also rely on either traditional keypad inputs or interactive LCD screens. While traditional keypad inputs may provide a lower cost implementation, they do not allow for more complex inputs or manipulations such as pattern or swipe motions. The use of LCD screens on the other hand increases the costs and complexity of the controller, as well as its footprint and overall size.

What is needed is a compact, low-cost, all-in-one security controller that provides for complex user inputs without relying on display screens for interactivity. The controller described and contemplated herein addresses these needs.

### SUMMARY

An improved small form factor controller includes a tactile input surface with a predetermined pattern of input regions. The pattern of input regions may be illuminated by the controller, and preferably would be generally imperceptible in the absence of illumination. The tactile input surface includes an array of regions that can be correlated with particular input regions on an illumination pattern. The tactile input surface includes an array of regions that can be correlated with particular input regions on an illumination pattern. A processor monitors for tactile input from the user and converts a motion pattern performed by the user to a sequence of corresponding activations, which is compared with stored user codes.

### BRIEF DESCRIPTION OF THE DRAWINGS

The present invention will be further explained with reference to the attached drawings, wherein like structures are referred to by like numerals and/or letters throughout the several views. The drawings shown are not necessarily to scale, with emphasis instead generally being placed upon illustrating the principles of the present invention.

FIG. 1a illustrates an exploded view diagram of an embodiment of the small form factor controller.

FIG. 1b illustrates an exploded view diagram of an embodiment of the small form factor controller.

FIG. 2a illustrates various layers of the input surface of an embodiment of the small form factor controller.

FIG. 2b illustrates various layers of the input surface of an embodiment of the small form factor controller.

FIG. 2c illustrates an exploded view of certain layers of the cover assembly.

FIG. 2d illustrates a top view of an embodiment of the capacitive layer showing an arrangement of the conductive traces and guard band.

FIG. 3a illustrates a perspective view of an embodiment of the small form factor controller, with the back side illumination engaged but no illumination of the front side surface.

FIG. 3b illustrates a top view of an embodiment of the small form factor controller with one physical button.

FIG. 3c illustrates a side view of an embodiment of the small form factor controller with a second physical button.

FIG. 3d illustrates a back view of an embodiment of the small form factor controller with the lighting source around the periphery of the device shaded to indicate illumination.

FIG. 4 illustrates a front view of an embodiment of the small form factor controller with illumination of the front side surface, which illuminates the predetermined input pattern that is shown here as a numeric keypad and status indicators.

### DETAILED DESCRIPTION

Embodiments of the present invention relate generally to, but are not limited to, wall-mounted and table surface mounted security system controllers and their input interfaces. An embodiment of the present invention provides a controller with a compact package for receiving user inputs through a user interface using capacitive touch. The controller contains a cover assembly that includes a number of layers, including an optically transmissive substrate layer as well as one or more paint layers. The controller also contains components for a security system controller including a processor, a proximity sensor, a siren, a speaker, a cellular radio (e.g., cellular module and antenna), a security sensor radio, and a battery backup. Preferably, the controller connects to a security system backend server or central station through the cellular radio without needing to rely on a locally installed but separate or additional device or hardware (e.g., router, wi-fi connector, etc.). The compact form on the controller provides a small footprint but the controller still provides the full functionality of an alarm panel within the compact controller without needing to connect to additional user devices.

In a preferred embodiment, the controller controls a security system through an input interface containing multiple capacitive touch regions arranged in a predetermined configuration. For example, the capacitive touch regions may be arranged in a 4×4 grid, providing 16 different user input regions. Alternatively, additional or fewer regions may be provided and the arrangement of the regions may vary depending on the needs of the system. For example, input regions corresponding to single digit numbers would require 10 regions in the interface. An additional set of regions may also be located in a separate area on the input layout.

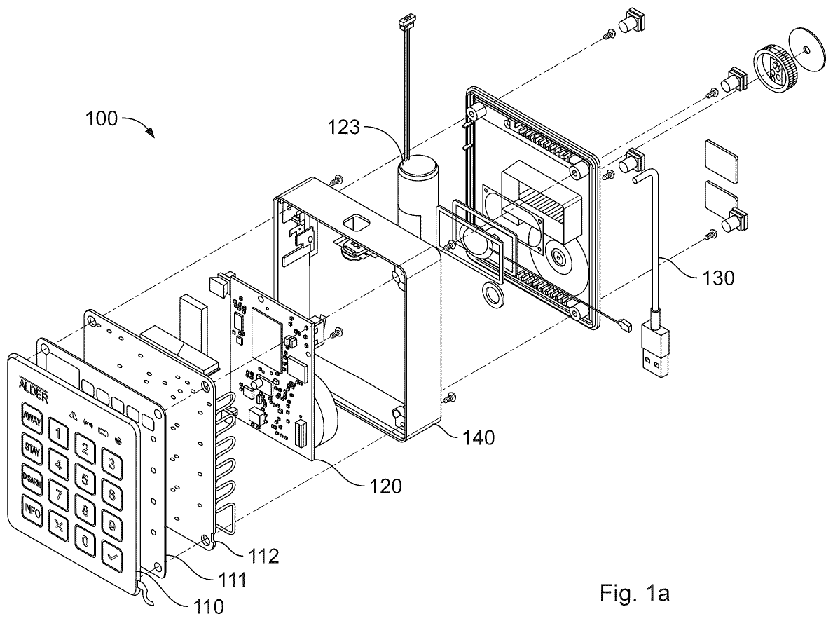

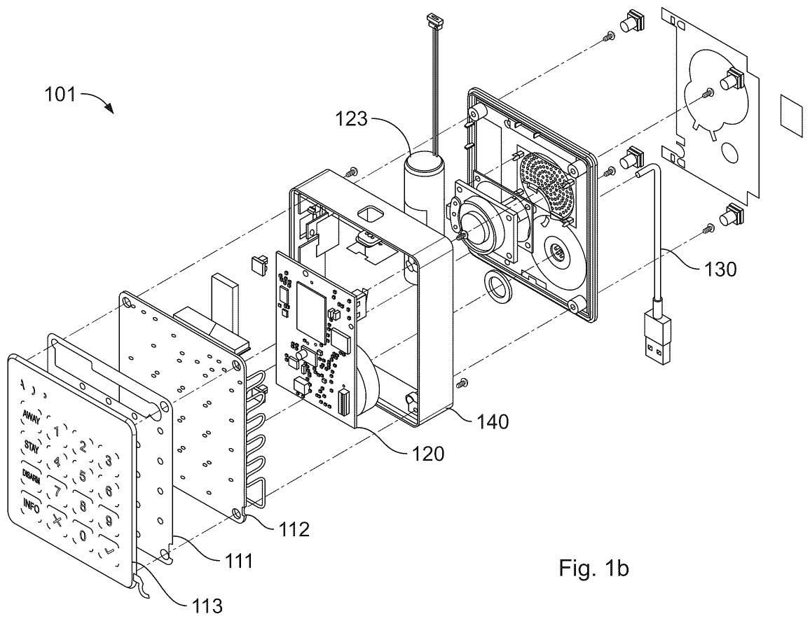

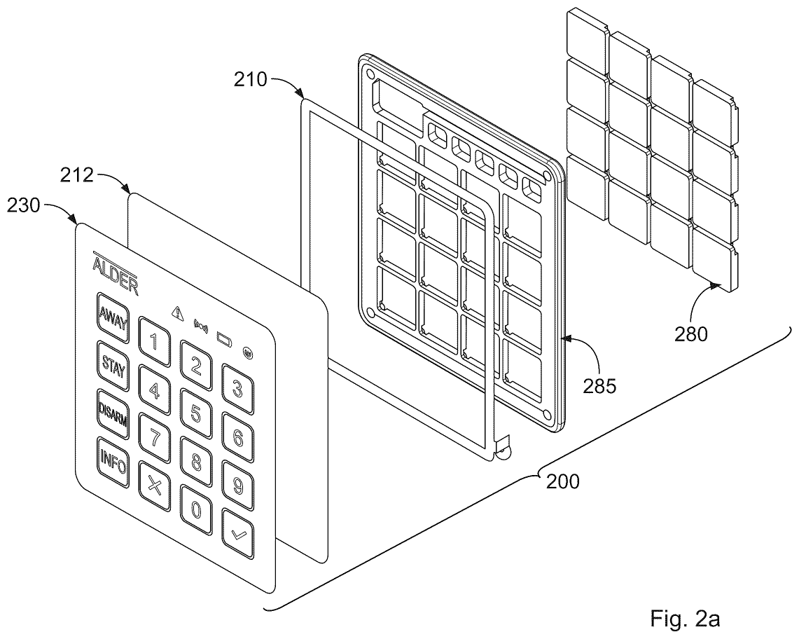

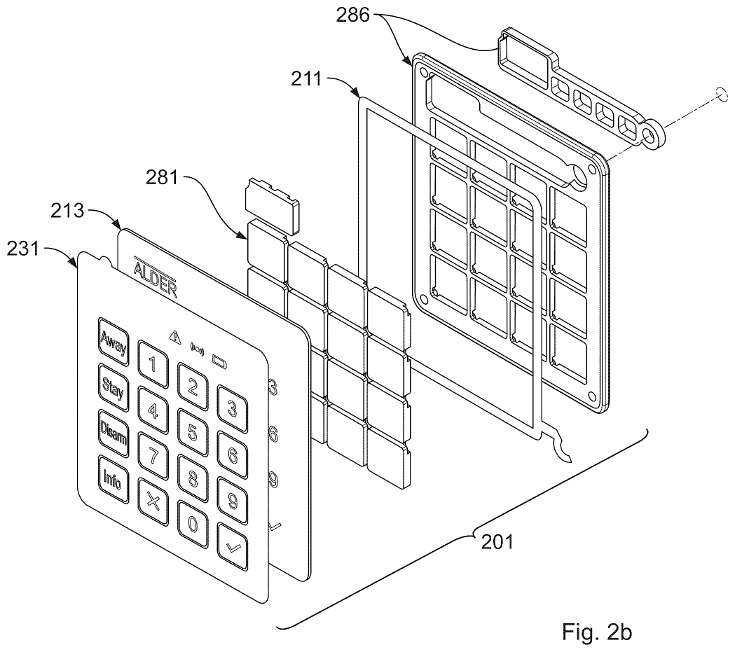

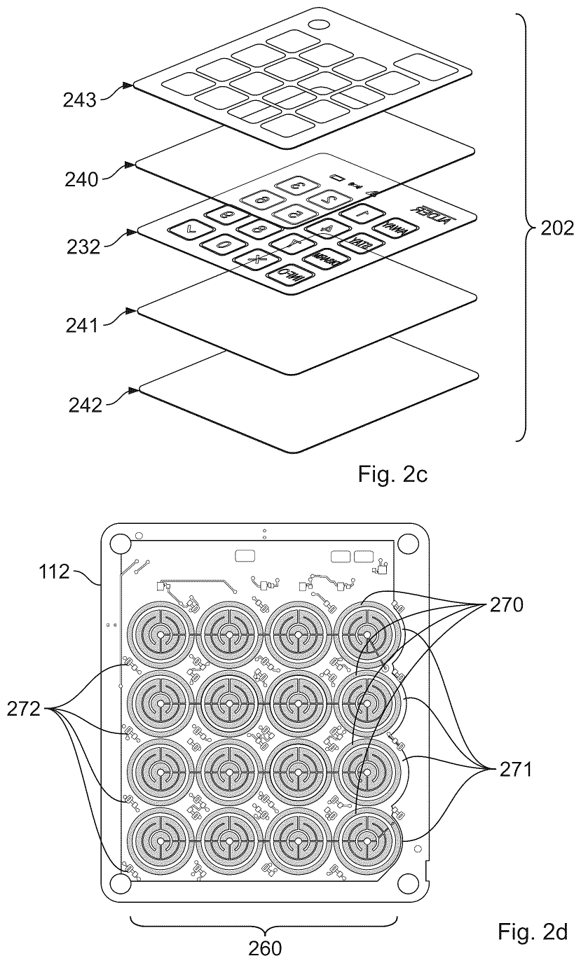

FIG. 1a illustrates various portions and layers of one embodiment of a small form factor controller 100 according to the invention. Preferably, the controller is an all-in-one device in a housing 140 for monitoring one or more sensor devices (not shown), and the controller contains an input interface 110, a capacitive touch assembly 112 adhered to the input interface 110 via an adhesive layer 111, a PCB 120 with a main processor, a wireless communications array for reporting system status or events associated with sensor conditions or user inputs, a speaker, and a piezoelectric alarm, a battery backup 123. Additionally, as shown in FIGS. 2a and 2b, the cover assemblies 200 and 201 of the controller contain a security sensor antenna (such as, without limitation, a 345 MHz antenna) 210, 211. Sensor devices (not shown) can include any number of wired or wireless sensors for detecting particular events or conditions (e.g., open/close conditions, glass break, gas or chemical detection, motion or decibel monitoring, etc.). Such sensors may communicate with the controller 100 on existing protocols used to network such devices, such as the 345 MHz band, LTE-M/LTE Cat M1, or NB-IoT. The controller 100 may be powered from a wall plug, through a USB connection 130, or through wiring into the wall at the location where the controller 100 is mounted. FIG. 1b similarly illustrates a controller with similar components as FIG. 1a, but with a different cover assembly 113 with variations in artwork and screening regions. The housing 140 of the controller also contains cover assembly 113 adheres to the capacitive touch assembly 112 via adhesive layer 111, and the PCB 120, along with battery 123 and USB cord 130.

With reference generally to FIGS. 2a-2c, the input interfaces (200, 201, and 202) preferably provide cover assemblies containing an artwork layer (230, 231, and 232) for the layouts of the cover assemblies. The input interfaces (200, 201, and 202) may include a layer of double sided adhesive 212, 213 for affixing artwork layer (230, 231, and 232) to other components of the input interfaces (200, 201, and 232). As illustrated in FIGS. 1a-1b, a separate capacitive touch assembly 112 contains the circuitry corresponding to the placement and arrangement of the capacitive touch regions corresponding to the input regions in the artwork layout (230, 231, and 232).

FIG. 1d illustrates a preferred embodiment of the capacitive touch regions formed by circular interdigitated connectors 270 and guard bands 271 surrounding the input region. The input interface for the controller includes an input surface that receives tactile forms of user input. The input surface provides a predetermined configuration and layout of touch-interactive regions, which are recognized and monitored for various user input. In a preferred embodiment, the input surface includes a capacitive tactile sensor array across the front-facing surface of the controller. The capacitive tactile sensor array contains m×n capacitive sensor units. Depending on the sensor array density and the number of desired user input regions on the input surface layout, the number of sensor units may correspond to the number of user input regions, or multiple sensor units may be grouped together for the same user input region.

As shown in FIG. 2d, a preferred embodiment of the PCB of the capacitive touch assembly 112 provides a plurality of capacitive touch input regions 260, each comprising conductive lines arranged as interdigitated fingers (e.g., 270), as well as a guard band 271 surrounding each input region 260 to improve isolation of each input region from the others. The foregoing arrangement enables sequential activation without tactile interruption (i.e., “swiping”). Specifically, when the user touches the capacitive touch panel 112 in a location overlapping with a guard band 271, the guard band 271 reduces or nulls the capacitance sensitivity in a gap region between adjacent input regions 260 so as to guarantee that the capacitance remains below the detection threshold, which will be interpreted as an end to activation of an input region 260 prior to activation of an adjacent input region 260 (i.e., simulates a finger lift in between input 260 regions when performing a “swipe” motion that does not involve lifting a finger). In an embodiment of the capacitive touch assembly 112, the guard band 271 has a width of at least 0.25 millimeters (mm) between any adjacent input regions 260, and preferably at least 0.4 mm in width. Additionally, in an embodiment of the capacitive touch assembly 112, the input regions 260 are spaced at least 1.5 mm apart, and preferably at least 2.5 mm apart, from one another.

With reference in particular to FIG. 2c, in a preferred embodiment of the cover assembly 202, the substrate comprises a clear polycarbonate layer 240 and at least one silver silkscreen layer 232 is painted on one surface of the polycarbonate layer 240. The silkscreen layer 232 provides artwork that includes gaps in the layer to define any input regions, message indicators, and other symbols or logos. The artwork 232 serves to obstruct the transmission of light through the cover assembly. At least one white paint film layer 241 is painted on the silkscreen layer 232. An anti-scratch film or other protective layer 242 may be applied on the white paint film layer 241. The cover assembly 202 preferably also includes an adhesive layer 243 applied to the other side of the polycarbonate substrate 240 (i.e., opposite the silkscreen layer 232), and the adhesive layer 243 preferably contains cutouts corresponding to any regions of user input or interaction through capacitive touch.

Alternatively, the cover assembly 202 may comprise the foregoing layers 232, 240, 241, 242, 243 arranged in one or more different orders. For example, the silver silkscreen 232 may be painted onto the opposite side of the substrate 240 as the white film layer 241. The anti-scratch protective layer 242 can then be applied to the white film layer 241 and the adhesive layer 243 can be applied to the silver silkscreen 232. Additionally, other paint layers may also be applied with different colors or patterns, or the white paint layer 241 may be of a different color or contain one or more patterns (not shown). Alternatively, the substrate 240 may be of a translucent material having an amount of opacity that still permits a predetermined amount of light to pass through. The substrate material may itself be tinted or colored as well, whether it is of a transparent or translucent material.

An embodiment of the input surface 110 is illustrated in FIG. 1a with user input regions corresponding to a numeric keypad with a row of status indicators, although other layouts can be presented to match with changes in the program or user customizations. Preferably, as shown in FIG. 2d, the controller includes one or more lighting elements (e.g., 272) such as an LED to illuminate the input surface.

In another embodiment, the input surface layout is then predetermined based on a pattern that is printed, embedded or machined into a panel 202. The panel substrate material has one degree of opaqueness or transparency for the transmission of light, and the pattern from the artwork introduces local changes to the opaqueness or transparency. Then, as the controller illuminates the input surface, the panel artwork blocks/transmits some amount of the light, and the layout pattern blocks/transmits a different amount of light, creating a contrasted display. The pattern could alternatively include additional different regions that also differ relatively from other regions in the pattern with respect to the degree of transmissibility, providing additional gradations in the lighted appearance of the display. In a preferred embodiment, the input surface with the panel has a generally uniform appearance in the absence of any illumination from the controller. Until the controller begins illumination, the layout pattern is not visible or is generally imperceptible.

With reference still to FIG. 2c, the cover assembly 202 generally provides for different regions of opacity and transmission of light such that under an illuminated condition, the artwork layer 232 of the cover assembly 202 provides contrast to make more visible the input regions, indicators, and icons provided by the cover assembly. In a preferred embodiment, the opacity of the white paint layer 241 obscures the presence of the silkscreen artwork layer 232 in the absence of illumination. Under illuminated conditions, light preferably transmits through the translucent portions that are unobstructed by the silkscreen layer 232 with sufficient luminance to be visible and provide clear contrast and definition of the regions obstructed by the silkscreen layer 232. In a preferred embodiment, the transmission of light through the cover assembly 232 in the unobstructed portions of the cover should be at least about 20%, as measured using an optical density meter or densitometer, such as a Linshang LS117 Optical Density Meter (currently commercially available at any of several retail sources).

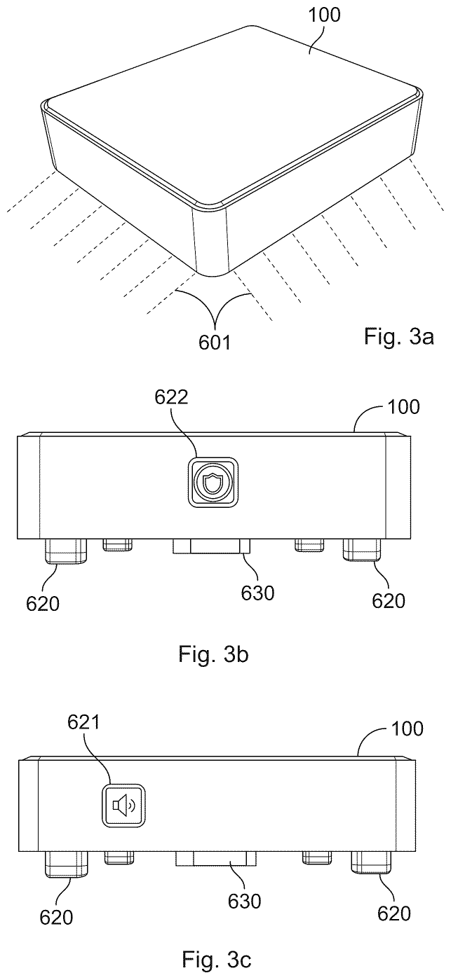

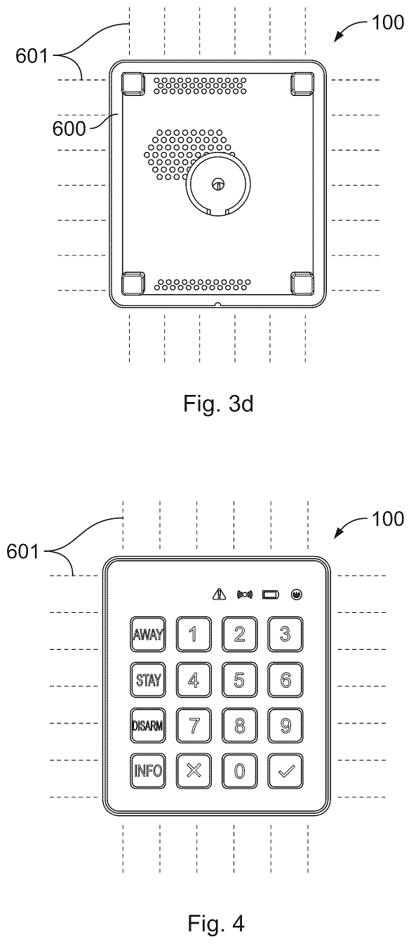

With reference back to FIGS. 2a and 2b, in an embodiment of the controller, the cover assemblies 200 and 201 also provide illumination through a lighting layer that includes a light guide panel 280, 281 and a plurality of side-emitting LEDs (e.g., 272 as shown in FIG. 2d). In a preferred embodiment, the light guide panel 280, 281 comprises a plurality of lenses 280, 281, each corresponding to a capacitive touch region as arranged in the capacitive touch assembly (as illustrated in FIG. 2d) 112. Each lens 280, 281 diffuses the light from the side-emitting LEDs outward through the user-facing surface 230, 231 of the cover assembly 200, 201. A second plurality of LEDs may also direct additional light inward into the controller 100, 101, which would then exit the controller through a side facing a wall or other surface proximate the controller (see, e.g., FIG. 3d). In some embodiments, the second plurality of LEDs provide multiple color frequencies through the use of multicolor LEDs. Alternatively, additional colors may be provided through sets of single-color LEDs having different predetermined colors.

In another alternative embodiment, the panel and pattern may be of different material or colors such that the layout pattern is readily visible or perceptible even in the absence of any illumination from the controller. For example, the pattern could be a dark, opaque film placed on a translucent panel (not shown), or the pattern could be a region of visible transparency on an opaque surface of the panel. The pattern may also include combinations of the foregoing so that some regions are always visible but others are only visible in an illuminated condition.

In a preferred embodiment, the panel is removable from the controller and can be replaced with other panels (not shown per se) having different predetermined layouts, text, symbols, or configurations. The controller can be updated by the user or by recognizing the new panel, adjusting its application input algorithms to match the types of input commands presented on the panel.

Each sensor unit can be matched to a predetermined region on the input surface layout. Alternatively, with more dense arrays, or if the pattern has fewer input regions, multiple sensor units may be grouped to correspond to the same predetermined region. The main processor monitors the capacitive sensor array to determine when and where a user has provided tactile input. The tactile input is interpreted by the main processor to correspond with the input regions on the predetermined panel being used, and the controller application responds accordingly. For example, on a panel presenting a numeric keypad, each touch by the user is matched by location to a number, creating a string of numbers representing the user's input code. The controller application then determines whether that user input code is authorized or not, and the application executes different subroutines (or generates an error notification) in response to that determination.

In an embodiment of the controller, the controller is also configured to compare user input sequences against stored passcodes. User inputs correspond to the capacitive regions arranged in the capacitive touch assembly (272, as illustrated in FIG. 2d) and the corresponding user input regions (230, 231 as illustrated in FIGS. 2a-2b) delineated in the artwork of the cover assembly (232 as illustrated in FIG. 2c). The controller stores the passcode sequences input by the user until the user has completed the input. Completion of the input may be indicated by a special input key (e.g., a done or ‘#’ input region). Completion of the input may also be indicated by passage of a minimum threshold of time without further user input (e.g., 1 second, or some other time period). Completion of the input may also be determined when the user has inputted a sufficient number of entries to correspond with the maximum allowed (e.g., six inputs for entry of a 6-digit passcode).

Upon completion of the user input sequence, the controller compares the input sequence to determine if it matches any stored entries. If the input matches a stored entry for a user, the controller is configured to execute a corresponding command based upon the state or status of the system. For example. If the system is in an armed state, the controller would disarm the system, and vice versa. Additionally, if the input matches a stored entry for a panic command, the system is configured to send an alert via the cellular communications module to the security backend server, notifying the monitoring service of the panic command. If the input does not match a stored entry, the controller is configured to execute a corresponding command to provide an error feedback to the user, which may be one or more of an audible tone, LED color, or LED behavior.

Additionally, in a preferred embodiment, the controller is also configured to accept user inputs provided in one or more motions or patterns, registering the continuous input motion or pattern as a sequence. With a sampling rate of at least 200 Hz, the controller is configured to monitor any contact of the user with any of the capacitive input regions and to note which one or more input regions are being contacted by the user. The controller can then monitor for sequential activation without tactile interruption. The controller receives the one or more inputs from the capacitive assembly and processes the input signals into a sequence of inputs. For simultaneous inputs of adjacent regions, while the user slides his/her finger from one region to the next, while maintaining tactile contact with the cover assembly, the controller can be configured to recognize the corresponding pattern and ignore the transition periods for purposes of sequencing the user's inputs. In a preferred embodiment of the capacitive assembly, the controller utilizes a guard band between the input regions (271 as illustrated in FIG. 2d) to help isolate the regions (270) from each other and reduce or avoid the instance of simultaneous key inputs during the transitions between input regions. The guard band effectively registers as a finger lift (i.e., an interruption of tactile contact) even though the user maintains tactile contact with the cover assembly.

In a preferred embodiment, the main processor of the controller monitors the capacitive sensor array to determine when a tactile input event has begun. As long as the user maintains contact with the input surface, the main processor registers the location or locations of contact and the sequence in which they occur. The sequence then corresponds to a motion pattern (such as a swipe motion) that is compared with authorized patterns stored for each user. The motion patterns may also include a combination of multiple simultaneous touches rather than a single, sequential touch. Combinations of numbers and motion patterns may also be used to form more complex sequences as part of a user's input code. Alternatively, the main processor can evaluate the sequence of contact locations, associating the location changes with the closest input regions to create an input string as if the user had touched each input region separately in the same order.

In a preferred embodiment, the controller is further configured to use different colors and behavior in the plurality of LEDs (272 as illustrated in FIG. 2d) to correspond to different states or status of the controller or security system (e.g., flashing, strobing, pulsing, other varied on-off timings and patterns, etc.) Accordingly, the controller is configured to use different colors and behavior of the LEDs to provide system status indicators to the user corresponding to the current system state or status. Additionally, the plurality of sets of LEDs may be used to deliver the same color and behavior or they may be configured to behave differently or use different color combinations depending on the configuration. For example, in a normal state for accepting user input, the controller may be configured to illuminate the cover assembly using the same color LED lighting (e.g. blue) in a steady state. However, for a state corresponding to a triggered alarm, the controller may be configured to illuminate a subset of the input regions a different color (e.g., red) and/or to differ the behavior of the illumination (e.g. strobing or switching between colors). Additionally, for example, the controller can be configured to briefly illuminate one or more LEDs corresponding to a capacitive input region based upon contact by the user, providing interactive feedback during the input process.

The controller in FIG. 1a also includes a light diffusing layer to assist with evenly redirecting and distributing the light to the input surface. Preferably, this diffusing layer provides an array of regions having an optical pattern or shape that is conducive to redirecting light out the front of controller, even though the illumination is from a side emitting LED or from light sources mounted towards the outer periphery of the controller.

The input interface preferably also includes a proximity sensor that detects the presence or movement of a nearby user. The proximity sensor may alternatively utilize near-field communication such as RFID, infrared, or Bluetooth to recognize the presence of an authorized, user-specific fob or device. Upon activation of the proximity sensor, the controller preferably illuminates one or more indicators on the controller.

In an embodiment of the controller and as illustrated in FIGS. 1a and 1b, the controller also contains a housing 140 for all of the controller components. As illustrated in FIG. 3d, the controller also includes a light guide in proximity to the side facing the wall. In a preferred embodiment, the light guide comprises an illuminating skirt 600 around the outer edge of the controller in proximity to the side facing the wall. The light guide preferably transmits light from the interior of the controller, illuminating 601 the wall region to which the controller is mounted in the same color light originating from the side-emitting LEDs. Alternatively, the light guide may accept light from an additional set of one or more LEDs paired with the light guide. In another embodiment, the light guide may be placed in the surface of the controller which faces the wall or other proximate surface, with the controller being mounted on elevated legs (620 as illustrated in FIGS. 3b-3c) to provide room for the illuminated light to project onto the wall and be visible to the user. Preferably, the LEDs of the controller (e.g., 272 as illustrated in FIG. 2d) would normally remain dormant until a triggering event, such as detection of the proximity of a user or a system alert. Upon detection of a triggering event, one or more of the LEDs (e.g., 272) in the controller would be turned on.

In a preferred embodiment, the controller has multiple states where different combinations of lighting sources are switched on. For example, in a first state of illumination, a lighting source located on the back side of the controller is turned on to provide lighting to the area immediately around where the controller 100 is located. FIG. 3a illustrates this illuminated state where the dotted lines 601 radiating from the periphery of the controller 100 indicate the illumination effect. FIGS. 3b-3c illustrate side views of an embodiment of the controller 100, and FIG. 3d illustrates the bottom of an embodiment of the controller 100. The radiating lines 601 in FIG. 3d also illustrate illumination from the back side lighting source of the controller 100, which corresponds to the shaded border around the periphery 600.

The top and side views show physical buttons may be placed along the outer sides of the controller, discretely providing additional user input buttons without altering the aesthetic appearance of the front side of the controller. For example, the side button shown in FIG. 3c may be a button 621 or buttons to change a setting or variable in the controller 100 (e.g., volume or brightness). Additionally, the top side button shown in FIG. 3b may be a panic button 622, which if held down by the user for a predetermined length of time, would place the controller in an emergency state and trigger specific routines (e.g., engaging the piezoelectric alarm and notifying a remote server or service of the emergency condition).

As shown in FIGS. 3b-3d, the embodiment of the controller 100 has a plurality of recessed legs 620 around the corners of the controller 100 and a mounting column 620 in the middle. The mounting column 630 and the recessed legs 620 secure the controller to the wall but also provide a gap for light to illuminate from behind the controller 100.

Additionally, the lighting source on the back side of the controller can preferably be programmatically controlled by the main processor to change its appearance, such as color, intensity, or frequency. The changes can correspond to different notifications for the user to visually receive. For example, the main processor could use one color to indicate normal operation of the system, but use a different color to indicate that an error or warning condition had occurred (low battery, lost connectivity, etc.) or that the system was in a particular mode (configuration mode, standby mode, armed/disarmed, etc.). Alternatively, the main processor could use different frequencies or variations of intensities (such as a blinking, strobe or pulsating effects) to provide additional visual notifications.

In a second state of illumination, the lighting source on the back side of the controller 100 remains on and the controller also illuminates the input surface on the front side of the controller 100. FIG. 4 illustrates this illumination state, with the numeric keypad pattern now visible (in contrast with FIG. 3a). As discussed before, this illuminates different parts of the input surface based upon the predetermined pattern being used. Additionally, the illumination of the front side of the controller could also be programmatically controlled. as discussed before, to provide different visual notifications to the user.

The state of the system can also be communicated by the controller to a remote server or monitoring service. In this embodiment, the controller would report changes in the system state and any events associated with the plurality of connected sensors. Depending on the reported change, the remote server or service could independently initiate additional actions, such as notifying an authorized user device and/or law enforcement.

Additionally, an embodiment of the controller also utilizes the wireless communication functionality in the controller to connect with a user's secondary devices, such as a tablet or mobile device application. This communication can be by any number of wireless protocols, including Wi-fi or cellular, and allows an authorized user device to interface with the controller. Upon verification of credentials, the controller would then be able to communicate its current status information to the connected device. In a preferred embodiment, the controller could also receive commands from the connected device, such as commands to arm/disarm or configuration instructions for the controller or system. Additionally, the application on the connected device may include an interface that corresponds to the predetermined pattern on the controller's input surface, serving as a second input to the controller.

1. A security system controller for controlling a security system comprising:
a. a housing for mounting the controller on a wall which comprises: a container body having an interior, a front opening, and a back side opposite the front opening; one or more legs extending from the back side of the container body for spacing said container body from a wall on which said housing is mounted; and one or more translucent panels which direct light toward the wall;
b. a surface panel positioned within said front opening of said housing and comprising:
a substrate having an exterior surface facing way from said housing and visible to a user, and an interior surface facing said interior of said housing;
a first layer of light diffusing material coating at least a portion of said interior surface of said substrate and having a first amount of translucence; and
a second layer of light obstructing material coating said first layer of light diffusing material and having a second amount of translucence,
wherein said second layer of light obstructing material covers a portion of said interior surface in accordance with a predefined artwork layout and said predefined artwork layout provides visual indications for one or more input regions on said exterior surface of said substrate;
c. a capacitive touch module aligned with and adjacent to said surface panel and comprising:
i. a circuit board including one or more capacitive touch input regions, each of which comprises conductive lines and each of which aligns with a corresponding one of said one or more input regions of said exterior surface of said substrate; and a plurality of guard bands each of which surrounds a corresponding one of said one or more input regions on said exterior surface of said substrate for increasing capacitive isolation of each input region from other input regions;
ii. a light guide for directing light from the interior of the container body and outward through the exterior surface of the substrate; and
iii. one or more side-emitting LEDs for illuminating said substrate positioned in proximity to said light guide, wherein said illumination transmits through said portions of said surface panel that are coated by only said first layer and not said second layer; and
d. a proximity sensor positioned in said housing and coupled to a microcontroller, wherein said microcontroller is configured to:
i. monitor a state of said proximity sensor, and
ii. upon a change in the state of the proximity sensor, activate said one or more side-emitting LEDs to indicate an operational state of said controller for receiving commands through additional user interaction with said capacitive touch module.

2. The security system controller of claim 1, wherein said light transmitted through said portions of said surface panel which are coated by only said first layer is at least 20%.

3. The security system controller of claim 1, wherein said predefined artwork layout of said second layer has substantially the same appearance as said first layer to a user facing said front opening of said housing when said controller is not in an illuminated state.

4. The security system controller of claim 1, wherein said guard band surrounding each of said one or more input regions has a width of at least about 0.25 millimeter.

5. The security system controller of claim 1, wherein said width of said guard band is at least about 0.4 millimeter.

6. The security system controller of claim 1, wherein said housing is substantially the same length and width of said surface panel.

7. The security system controller of claim 1, wherein said substrate of said surface panel substantially fills said front opening of said housing, wherein said substrate lacks a programmable display screen.

8. The security system controller of claim 1, wherein said proximity sensor further comprises a sensor for detecting near-field communications, said sensor comprises one or more technology selected from: RFID, infrared, and Bluetooth.

9. The security system controller of claim 1, wherein said housing further comprises a physical button, a physical switch, or both, each of which is positioned on said container body and each of which, independently, enables one or more user controlled functions.

10. The security system controller of claim 1, further comprising a cellular radio.

11. The security system controller of claim 1, further comprising a security sensor radio.

12. The security system controller of claim 10, wherein said security sensor radio utilizes a communications protocol including at least one of LTE-M, LTE-Cat M1, or NB-IOT.

13. The security system controller of claim 11, wherein said microcontroller is further configured to
a. monitor through said security sensor radio one or more additional sensors, including at least a door sensor, a window sensor, a smoke detector, a gas detector, a chemical detector, a motion sensor, a glass break sensor and a decibel monitoring sensor and
b. determine a state of said security system based upon said state of said one or more additional sensors.

14. The security system controller of claim 13, wherein said microcontroller is further configured to communicate said state of said security system to a security system backend server through said cellular radio.

15. The security system controller of claim 13, wherein said microcontroller is further configured to periodically communicate said state of said security system to said backend server after a predetermined interval of time.

16. The security system controller of claim 13, wherein said microcontroller is further configured to:
a. receive a signal from said one or more additional sensors indicating a change in the state of said additional sensor
b. communicate information regarding said state of said additional sensor and said state of said security system with an application on one or more peripheral devices, including at least a computer, mobile device, and tablet.

17. The security system controller of claim 16, further comprising an additional set of one or more LEDs, wherein said microcontroller is further configured to activate said additional set of one or more LEDs upon receiving said signal from said one or more additional sensors.

18. The security system controller of claim 13, wherein said microcontroller is further configured to:
a. communicate information regarding said state of said security system with an application on one or more peripheral devices, including at least a computer, mobile device, and tablet,
b. receive a command from said one or more peripheral devices,
c. select a predetermined system action from said plurality of available system actions corresponding to said received command, and
d. communicate information regarding said predetermined system action to said security system backend.

19. The security system controller of claim 18, wherein said predetermined system action comprises changing said state of said security system.

20. The security system controller of claim 13, wherein said housing further comprises one or more interior LEDs for illuminating said one or more translucent panels and wherein said microcontroller is further configured to activate one of said one or more interior LEDs to indicate said state of said security system.

21. The security system controller of claim 20, wherein said housing further comprises a plurality of interior LEDs of different colors.

22. The security system controller of claim 20, wherein said microcontroller is configured to periodically change the intensity of said activated interior LEDs according to a predetermined pattern of frequency and duration.

23. The security system controller of claim 22, wherein said predetermined pattern of frequency and duration results in any one of a pulsating, blinking, or strobe effect.

24. The security system controller of claim 20, wherein said microcontroller is further programmed to register a continuous input motion as a sequence of inputs by:
a. detecting a first capacitance change in one of said one or more conductive trace regions corresponding to user contact with a first of said one or more input regions,
b. detecting a second capacitance change in the one or more conductive trace regions corresponding to user contact with a region adjacent to said first input region corresponding to said conductive band,
c. registering said first and second capacitance changes as an input command corresponding to a user pressing said first conductive trace regions registering said first capacitance change,
d. detecting a third capacitance change in one of said one or more conductive trace regions corresponding to user contact with another of said one or more input regions
e. detecting a fourth capacitance change in the one or more conductive trace regions corresponding to user contact with a region adjacent to said another input regions corresponding to said conductive band, and
f. registering said third and fourth capacitance changes as a second input command corresponding to said user pressing said another conductive trace regions registering said third capacitance change, and
g. combining said first and second input commands to append to a passcode sequence.

25. The security system controller of claim 24, wherein said first and second input commands are the same.

26. The security system controller of claim 24, wherein said microcontroller is configured to continue registering input commands to append to said passcode sequence until a predetermined number of input commands is reached.

27. The security system controller of claim 24, wherein said microcontroller is configured to continue registering input commands to append to said passcode sequence until a predetermined input command is entered to indicate termination of the passcode sequence input.

28. The security system controller of claim 24, wherein said microcontroller is configured to continue registering input commands to append to said passcode sequence until a predetermined length of time has lapsed.

29. The security system controller of claim 1, further comprising at least one of: a battery backup, a speaker, and a siren.
